(19) United States
(12) Patent Application Publication
(10) Pub. No.: US 2025/0076124 A1
(43) Pub. Date: Mar. 6, 2025

(54) BOLOMETER, DETECTION METHOD, AND BOLOMETER MANUFACTURING METHOD

(71) Applicant: NEC Corporation, Minato-ku (JP)

(72) Inventor: Noriyuki TONOUCHI, Tokyo (JP)

(73) Assignee: NEC Corporation, Minato-ku (JP)

(21) Appl. No.: 18/772,245

(22) Filed: Jul. 14, 2024

(30) Foreign Application Priority Data
Aug. 28, 2023 (JP) 2023-138339

(51) Int. Cl. G01J 5/24; G01J 5/08

(52) U.S. Cl. CPC G01J 5/24; G01J 5/0853

(57) ABSTRACT

A bolometer of the disclosure includes a gate electrode to which a gate voltage is configured to be applied, a drain electrode to which a drain voltage is configured to be applied, a source electrode, and a first film that connects the drain electrode and the source electrode and includes a carbon nanotube, in which, when the drain voltage is negative, the gate voltage is set between a first upper limit value and a first lower limit value, the first upper limit value is the gate voltage when a drain current of the drain electrode is at a minimum.

The application is on the basis of Japanese Patent Application No. 2023-138339 filed on Aug. 28, 2023, and the contents thereof are incorporated herein by reference.

### TECHNICAL FIELD

The disclosure relates to a bolometer, a detection method, and a bolometer manufacturing method.

### BACKGROUND ART

It is known that a bolometer is used as an infrared sensor.

For example, Japanese Unexamined Patent Application, First Publication No. 2015-49207 (hereinafter Patent Document 1) discloses a bolometer with an improved temperature coefficient of resistance (TCR) related to an improvement in the performance of an infrared sensor by using a semiconductor carbon nano tube (CNT).

In an infrared light-receiving element disclosed in Patent Document 1, a channel part is doped with a control member containing an electrolyte, thereby controlling the position of the Fermi energy in the channel part containing a CNT. In addition, it is disclosed that, in the infrared light-receiving element, a voltage between a source electrode and a drain electrode and a voltage between the source electrode and a gate electrode are controlled, and thus the position of the Fermi energy of the channel part containing the CNT can also be controlled. Consequently, the value of a TCR can be controlled.

### SUMMARY

However, it may be difficult to achieve a high TCR depending on a target voltage value.

An example object of the disclosure is to provide a bolometer, a detection method, and a bolometer manufacturing method for solving the above-described problems.

A bolometer of the disclosure is a bolometer including a gate electrode to which a gate voltage is configured to be applied, a drain electrode to which a drain voltage is configured to be applied, a source electrode, and a first film that connects the drain electrode and the source electrode and includes a carbon nanotube, in which, when the drain voltage is negative, the gate voltage is set between a first upper limit value and a first lower limit value, the first upper limit value is the gate voltage when a drain current of the drain electrode is at a minimum, and the first lower limit value is the gate voltage that satisfies relationships shown in the following equation:

$$first lower limit value = first upper limit value - ( first upper limit value - median ) \times 2$$

$$where ,$$

$$median = argmax \vert \frac{dlog \vert {I}_{total} ( {V}_{g} ) \vert}{{d V}_{g}} \vert .$$

A detection method of the disclosure is a detection method for a bolometer including a gate electrode, a drain electrode, a source electrode, and a first film that connects the drain electrode and the source electrode and includes a carbon nanotube, the detection method including applying a negative drain voltage to the drain electrode, applying a gate voltage between a first upper limit value and a first lower limit value to the gate electrode, and detecting infrared rays, in which the first upper limit value is the gate voltage when a drain current of the drain electrode is at a minimum, and the first lower limit value is the gate voltage that satisfies relationships shown in the following equation:

$$first lower limit value = first upper limit value - ( first upper limit value - median ) \times 2$$

$$where ,$$

$$median = argmax \vert \frac{dlog \vert {I}_{total} ( {V}_{g} ) \vert}{{d V}_{g}} \vert .$$

A bolometer manufacturing method of the disclosure includes laminating a first film that connects a drain electrode and a source electrode and includes a carbon nanotube, and providing a second film on a surface of the first film, the second film performing a doping action on the first film, in which, in the providing of the second film, the second film is provided such that a gate voltage applied to a gate electrode is set between a first upper limit value and a first lower limit value when a drain voltage applied to the drain electrode is negative, the first upper limit value is the gate voltage when a drain current of the drain electrode is at a minimum, and the first lower limit value is the gate voltage that satisfies relationships shown in the following equation:

$$first lower limit value = first upper limit value - ( first upper limit value - median ) \times 2$$

$$where ,$$

$$median = argmax \vert \frac{dlog \vert {I}_{total} ( {V}_{g} ) \vert}{{d V}_{g}} \vert .$$

According to a bolometer, a detection method, and a bolometer manufacturing method according to the disclosure, it is easy to achieve a high TCR.

### BRIEF DESCRIPTION OF THE DRAWINGS

FIG. 1 is a cross-sectional view I showing an example of a configuration of a bolometer according to the disclosure.

FIG. 2 is a graph I showing an example of transport characteristics of the bolometer according to the disclosure.

FIG. 3 is a graph II showing an example of transport characteristics of the bolometer according to the disclosure.

FIG. 4 is a graph I showing an example of a gradient of transport characteristics which is calculated based on the transport characteristics of the bolometer according to the disclosure.

FIG. 5 is a flowchart I showing an example of processing of a detection method according to the disclosure.

FIG. 6 is a graph showing a relationship between a TCR of the bolometer and a gradient of transport characteristics according to the disclosure.

FIG. 7 is a cross-sectional view II showing an example of a configuration of the bolometer according to the disclosure.

FIG. 8 is a graph III showing an example of transport characteristics of the bolometer according to the disclosure.

FIG. 9 is a graph II showing an example of a gradient of transport characteristics which is calculated based on the transport characteristics of the bolometer according to the disclosure.

FIG. 10 is a flowchart showing an example of processing of a bolometer manufacturing method according to the disclosure.

FIG. 11 is a graph IV showing an example of transport characteristics of the bolometer according to the disclosure.

FIG. 12 is a cross-sectional view III showing an example of a configuration of the bolometer according to the disclosure.

FIG. 13 is a flowchart II showing an example of processing of a detection method according to the disclosure.

### EXAMPLE EMBODIMENT

Each example embodiment of the disclosure will be described below with reference to the drawings. The drawings and specific configurations used in each example embodiment should not be used to interpret the disclosure. The same or equivalent configurations in all of the drawings will be denoted by the same reference numerals and signs, and common descriptions will be omitted.

The drawings in the disclosure are related to one or more example embodiments.

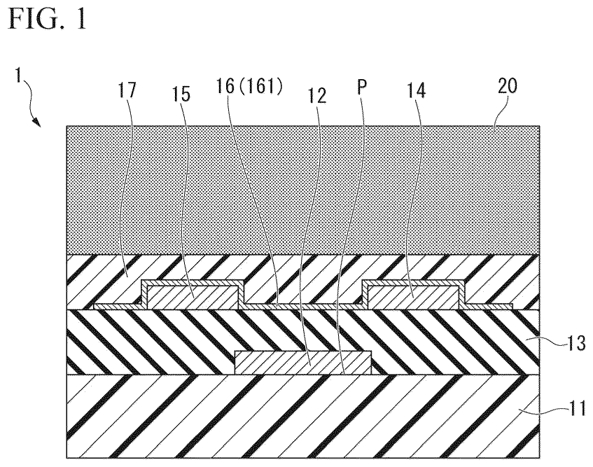

Hereinafter, an example of a configuration of a bolometer in the disclosure will be described with reference to FIGS. 1 to 4.

### (Configuration of Bolometer)

A bolometer 1 is used in a sensor for detecting infrared rays.

As showed in FIG. 1, the bolometer 1 includes a substrate 11, a gate electrode 12, an insulating layer 13, a drain electrode 14, a source electrode 15, a first film 16, a second film 17, and an infrared ray absorption layer 20.

### (Substrate)

The substrate 11 is a Si substrate processed using a silicon wafer.

For example, a read-out circuit may be formed on the substrate 11.

For example, in the substrate 11, a micro electro mechanical systems (MEMS) structure in which a lower portion of the bolometer is formed as a hollow in order to secure a sufficient temperature rise accompanying absorption of infrared rays may be formed.

For example, a polymer film such as Parylene (registered trademark) having a low thermal conductivity may be formed on the substrate 11 in order to secure heat insulation.

For example, the substrate 11 may include an electrically insulating base insulating layer. Methods of forming the base insulating layer include a method of performing heat treatment on the substrate 11, a method of directly forming the base insulating layer by a chemical vapor deposition (CVD) method, a method of forming a polymer film by applying a solution containing dissolved polymers or polymer precursors by spin coating and performing heating processing, and the like. Examples of the base insulating layer include silicon oxide, silicon nitride, polyimide, Parylene (registered trademark), and the like.

A portion P of the surface of the substrate 11 is provided with the gate electrode 12 which will be described below.

### (Insulating Layer)

The insulating layer 13 is partially provided on the surface of the substrate 11 with the gate electrode 12 interposed therebetween.

The insulating layer 13 is laminated to cover the surface of the substrate 11 and the surface of the gate electrode 12.

For example, the insulating layer 13 may have such a thickness as to protect the first film 16 from P-type doping with water or oxygen.

### (Gate Electrode)

The gate electrode 12 is provided on the surface of the substrate 11.

A gate voltage can be applied to the gate electrode 12.

The gate voltage is a voltage applied to the gate electrode 12 with respect to the source electrode 15.

### (Drain Electrode)

The drain electrode 14 is provided on the surface of the insulating layer 13.

A drain voltage can be applied to the drain electrode 14.

The drain voltage is a voltage applied to the drain electrode 14 with respect to the source electrode 15.

For example, a negative voltage may be applied as the drain voltage.

### (Source Electrode)

The source electrode 15 is provided on the surface of the insulating layer 13.

For example, the source electrode 15 is connected to a GND (ground).

### (First Film)

The first film 16 connects the drain electrode 14 and the source electrode 15.

For example, the first film 16 covers the drain electrode 14 and the source electrode 15.

The first film 16 contains a CNT 161.

For example, in the disclosure, the first film 16 has a CNT network formed by a plurality of CNTs 161.

Carriers in the CNT 161 contained in the first film 16 are induced by a gate voltage. Thereby, a drain current flows between the drain electrode 14 and the source electrode 15.

The induced carriers in the CNT 161 change depending on a doping action of the second film 17 which will be described below.

The CNT 161 is a fibrous material with a diameter of 0.6 nm to 1.5 nm and a length of 100 nm to 5.0 um. The properties of the CNT 161 change depending on how six-membered rings are arranged in the circumferential direction.

Regarding the CNT 161, a cylindrical CNT made from a single graphene sheet is referred to as a single-layer CNT, and a plurality of CNTs having different diameters, overlapping each other coaxially, and formed as a plurality of layers is referred to as a multi-layer CNT. CNTs that are formed as a bilayer are referred to as a two-layer CNT.

For example, the CNT 161 may be any of a single-layer CNT, a two-layer CNT, or a multi-layer CNT.

As an example, the CNT 161 according to the disclosure is a single-layer CNT.

There are two types of CNT 161, that is, a semiconductor type that shows semiconducting properties and a metallic type that shows metallic properties. A single-layer CNT usually contains a 2:1 ratio of a semiconductor type CNT and a metallic type CNT. For this reason, when a large number of CNTs that show one type of property are used, a separation process is necessary.

For example, the CNT 161 may be a semiconductor type CNT. Thereby, an absolute value of a TCR of the bolometer 1 can be improved.

### (Second Film)

The second film 17 is provided on the surface of the first film 16.

The second film 17 performs a doping action on the first film 16.

The second film 17 gives the CNTs 161 contained in the first film 16 an action of donating electrons (carriers induced by a gate voltage become electrons: N-type doping) or extracting electrons (carriers induced by a gate voltage become holes: P-type doping) by a doping action.

For example, the second film 17 contains PMMA. A polymethyl methacrylate (PMMA) film formed using a PMMA solution dissolved in anisole performs P-type doping on the CNTs 161 contained in the first film 16.

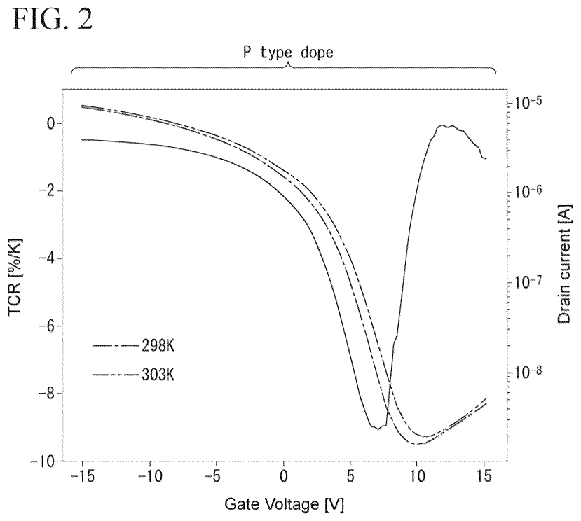

FIG. 2 shows transport characteristics of the bolometer 1 having a CNT network, which is obtained by performing P-type doping on the CNTs 161, in the first film 16.

FIG. 2 shows the value of a drain current obtained by each gate voltage value when a gate voltage is swept over in a predetermined range for the bolometer 1 as transport characteristics.

In FIG. 2, an alternating two dots-dashed line represents transport characteristics when a drain voltage of −0.1 V is applied to the bolometer 1 under an environment of 303 K. In FIG. 2, an alternating dotted-dashed line represents transport characteristics when a drain voltage of −0.1 V is applied to the bolometer 1 under an environment of 298 K. In FIG. 2, a gate voltage is swept over in a range of −15 V to 15 V from each state, and the value of a drain current (I_{d}) obtained by each gate voltage value (Gate Voltage: V_{g}) is shown as each of transport characteristics. In FIG. 2, a solid line is a curve (TCR curve) that indicates the value of a TCR, which is calculated based on the transport characteristics indicated by the alternating two dots-dashed line and the transport characteristics indicated by the alternating dotted-dashed line, for each gate voltage value.

For example, the second film 17 may be an insulating film of, such as silicon oxide or alumina.

### (Infrared Ray Absorption Layer)

The infrared ray absorption layer 20 may be provided to improve the amount of infrared rays absorbed by the bolometer 1.

The infrared ray absorption layer 20 is provided on the surface of the second film 17.

Materials used for the infrared ray absorption layer 20 may include carbon materials such as gold black, carbon nanotube, carbon nanohorn, and carbon black, composite materials of carbon materials and polymer resins, or the like. At this time, PVA, PMMA, P4VP, and the like can be used as a polymer resin, but it is not limited to these three types as long as a CNT can be uniformly dispersed and the structure of the polymer resin can be maintained.

### (Upper Limit Value and Lower Limit Value of Gate Voltage)

For example, in the bolometer 1, when a drain voltage is negative, a gate voltage is set between a first upper limit value and a first lower limit value, which will be described below.

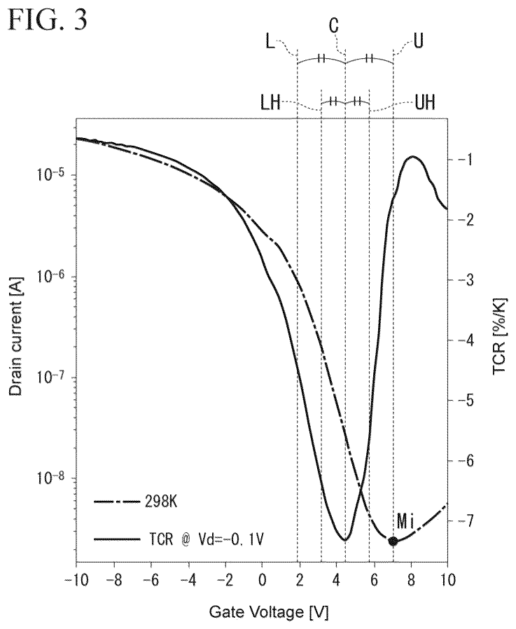

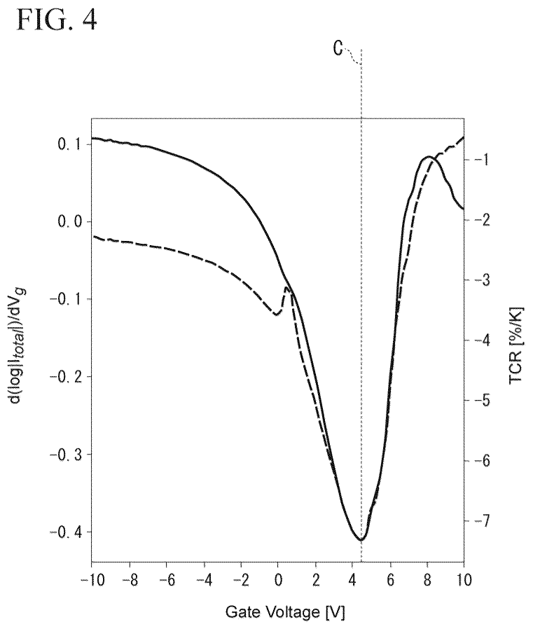

Here, the “first upper limit value” and the “first lower limit value” of the gate voltage will be described in detail with reference to FIGS. 3 and 4. Determination of the first upper limit value, the first lower limit value, and a median, which will be described below, corresponds to some processes of a detection method according to the disclosure.

In FIGS. 3 and 4, P-type doping is performed on the CNT 161 using a PMMA film (second film 17) formed using an anisole-dispersed PMMA solution.

In FIG. 3, an alternating dotted-dashed line represents a single piece of I_{d} V_{g} data (transport characteristic) obtained by sweeping over a gate voltage from a state where a drain voltage (V_{d}) of −0.1 V is applied to the bolometer 1 under an environment of 298 K.

In FIG. 3, a solid line is a TCR curve that indicates the value of a TCR value in each gate voltage value, which is calculated based on the I_{d} V_{g} data under two different temperature environments. The TCR curve indicated by the solid line is calculated based on the above-mentioned I_{d} V_{g} data under the environment of 298 K and I_{d} V_{g} data under an environment of 303 K with a different temperature.

The first upper limit value of the gate voltage is a gate voltage shown by a line U in FIG. 3 at a point Mi where the drain current I_{d} of the drain electrode 14 is at a minimum.

The first lower limit value of the gate voltage is a gate voltage that satisfies the relationships of the following Equations (1) and (2) in, such as the line L shown in FIG. 3. Here, an argmax function is a variable when a maximum value is achieved. In Equation (1), |d log|Iₜₒₜₐₗ(V_{g})|/dV_{g}| is V_{g} when a maximum value is achieved. When a current flowing through the bolometer 1 is set to be Iₜₒₜₐₗ, the value of a gate voltage at which an absolute value of a TCR is maximized can be estimated from a single piece of I_{d} V_{g} data (transport characteristic) as shown in Equation (1). In the disclosure, Iₜₒₜₐₗ indicates a drain current I_{d}, V_{g} indicates a gate voltage, and a median to be calculated indicates a gate voltage value at which the absolute value of the TCR is at a maximum. The median of the gate voltage shown by Equation (1) is a gate voltage value indicated by a line C which will be described below.

As shown in FIG. 3, the line Lis line-symmetrical to the line U in the line C.

$$Median = argmax \vert \frac{dlog \vert {I}_{total} ( {V}_{g} ) \vert}{{d V}_{g}} \vert \qquad Equation ( 1 )$$

$$first lower limit value = first upper limit value - ( first upper limit value - median ) \times 2 \qquad Equation ( 2 )$$

In FIG. 4, a solid line represents the TCR value transferred from FIG. 3.

In FIG. 4, a dashed line is d log|Iₜₒₜₐₗ(V_{g})|/dV_{g} calculated from the I_{d} V_{g} data represented by the alternating dotted-dashed line in FIG. 3.

As shown in FIG. 4, a gate voltage at which the absolute value of the TCR is at a maximum and a gate voltage of argmax|d log|Iₜₒₜₐₗ(V_{g})|/dV_{g}| match at the gate voltage shown by the line C.

For example, in the bolometer 1, when a drain voltage is negative, a gate voltage may be set between a second upper limit value and a second lower limit value, which will be described below.

In addition, the second upper limit value may be set based on a median of the gate voltage.

Furthermore, the second lower limit value may be set based on the median of the gate voltage.

The second upper limit value is a gate voltage that satisfies a relationship shown in Equation (3) in, such as a line UH shown in FIG. 3.

In this case, the second lower limit value is a gate voltage that satisfies a relationship shown in Equation (4) in, such as a line LH shown in FIG. 3.

$$Second upper limit value = median + ( upper limit value - median ) / 2 \qquad Equation ( 3 )$$

$$Second lower limit value = second upper limit value - ( second upper limit value - median ) \times 2 \qquad Equation ( 4 )$$

### (Detection Method)

An example of a method of detecting infrared rays using the bolometer 1 according to the disclosure will be described.

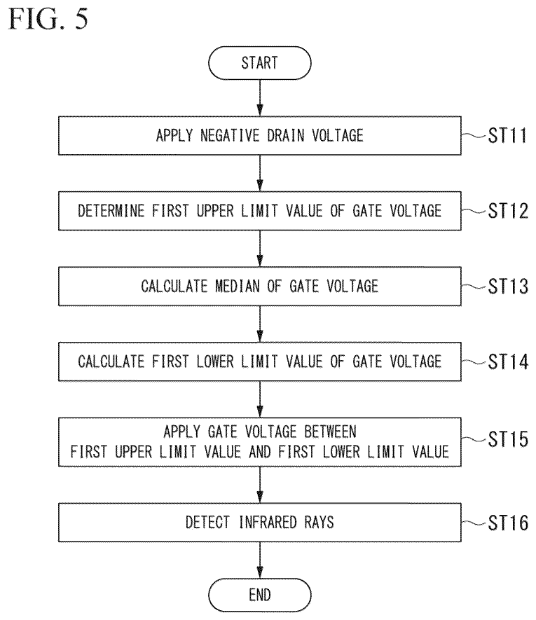

An example of the method of detecting infrared rays using the bolometer 1 according to the disclosure is performed in accordance with a flow shown in FIG. 5.

First, an operator applies a negative drain voltage to the drain electrode 14 (ST11).

Specifically, the operator applies a negative drain voltage to the bolometer including the gate electrode 12, the drain electrode 14, the source electrode 15, and the first film 16 that connects the drain electrode 14 and the source electrode 15 and contains a carbon nanotube.

Next, the operator determines a first upper limit value of a gate voltage (ST12).

The first upper limit value is the gate voltage when the drain current of the drain electrode 14 is at a minimum.

The operator sweeps over a gate voltage in a predetermined range from a state where the drain voltage is applied in ST11 to acquire transport characteristics showing the value of a drain current obtained by each gate voltage value. Then, the operator obtains a gate voltage when the drain current of the drain electrode 14 is at a minimum with regard to the transport characteristics and determines this gate voltage as the first upper limit value.

Next, the operator calculates a median of the gate voltage (ST13).

The operator calculates the median of the gate voltage from Equation (1) described above.

Next, the operator calculates a first lower limit value of a gate voltage (ST14).

The first lower limit value is the gate voltage that satisfies the relationships shown in Equations (1) and (2).

The operator calculates the first lower limit value from the calculated median of the gate voltage.

Next, the operator applies a gate voltage between the first upper limit value and the first lower limit value to the gate electrode 12 (ST15).

The operator can apply the gate voltage between the first upper limit value and the first lower limit value to apply a gate voltage to near a gate voltage value at which an absolute value of a TCR is maximized.

Next, the operator detects infrared rays by the bolometer 1 (ST16).

Here, infrared rays are detected in a state where the absolute value of the TCR can be maximized by the gate voltage value applied in ST15. (completed)

### (Action and Effect)

According to the bolometer 1 of the disclosure, a gate voltage between a first upper limit value and a first lower limit value is applied, and thus it is possible to apply a gate voltage to near a gate voltage at which an absolute value of a TCR is maximized.

Thus, in the bolometer 1 of the disclosure, it is easy to achieve a high TCR.

As a comparative example, a bolometer having an electric double-layer transistor structure will be cited.

An advantage of adopting the electric double-layer transistor structure is that carriers can be controlled with a low gate voltage, but there are also many problems.

Examples of an electrolyte material for an electric double-layer transistor include an ionic liquid, salt-dissolved water, an organic solvent, ionic gel containing these, and the like, but these are difficult to be miniaturized. For this reason, there is a problem that it is difficult to achieve an array in a bolometer.

Further, a potential window of an electrolyte is approximately several volts, which limits a voltage that can be applied. For this reason, there is also a problem that, when an excessive gate voltage is applied, an electrolyte deteriorates, and a material tends to deteriorate.

In contrast to the comparative example, in the bolometer 1 according to the disclosure, a CNT network can be used as a bolometer resistor with a gate voltage controlled to near a gate voltage at which an absolute value of a TCR is maximized. Thereby, it is easy to achieve a high TCR and expect to improve detection performance of the bolometer.

In addition, the components of the bolometer 1 according to the disclosure can be manufactured using a semiconductor process of the related art, and thus problems with miniaturization and material deterioration as in the comparative example are unlikely to occur.

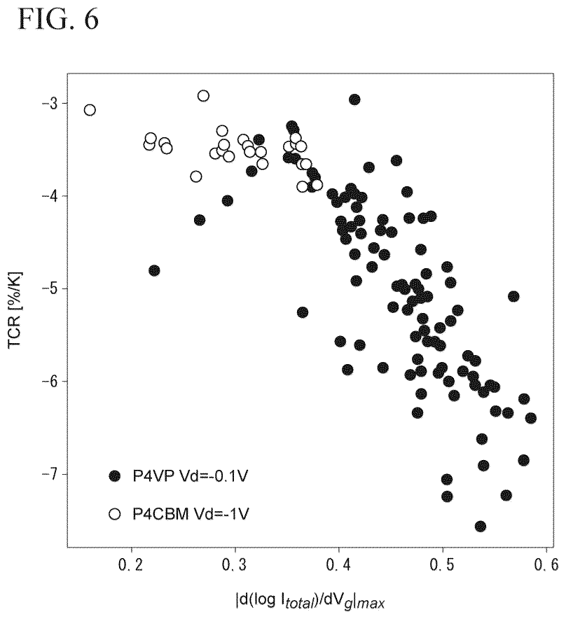

Additionally, in the disclosure, as shown in FIG. 6, it has been confirmed that the larger a gradient of transport characteristic data, the larger an absolute value of a TCR.

FIG. 6 is a diagram showing a relationship between a TCR (vertical axis) calculated based on I_{d} V_{g} data of 298 K and 303 K and a maximum value (horizontal axis) of a gradient |d log|Iₜₒₜₐₗ(V_{g})|/dV_{g}| of transport characteristic data with respect to a carbon nanotube-thin film transistor (CNT-TFT) using poly(4-vinylpyridine) (P4VP) and poly(4-vinylpyridine-co-butyl methacrylate) (P4VBM) as a protective film. The larger the gradient of the transport characteristic data, the larger the absolute value of the TCR, and a correlation therebetween can be confirmed. That is, it can be said that, as the gradient of the I_{d} V_{g} data becomes larger, the TCR tends to become larger.

In the CNT-TFT, when comparing a hole current (a current on a negative side of a point where a current value is at a minimum in the I_{d} V_{g} data as shown in FIGS. 2 and 3) and an electron current (a current on a positive side of the point where a current value is at a minimum in the I_{d} V_{g} data as shown in FIGS. 2 and 3), a gradient of an I_{d} V_{g} curve is often larger for the hole current. For this reason, it is considered that a point where an absolute value of a TCR is maximized tends to be located on a negative side of a current minimum point.

In the bolometer 1 of the disclosure, it is possible to obtain the following effects by “the bolometer 1 including the gate electrode 12 to which a gate voltage can be applied, the drain electrode 14 to which a drain voltage can be applied, the source electrode 15, and the first film 16 that connects the drain electrode 14 and the source electrode 15 and contains the carbon nanotube 161, in which when the drain voltage is negative, the gate voltage is set between a first upper limit value and a first lower limit value, and the first upper limit value is the gate voltage when a drain current of the drain electrode 14 is at a minimum, and the first lower limit value is the gate voltage that satisfies relationships shown in Equations (1) and (2)”.

In the bolometer 1 of the disclosure, it is possible to obtain an effect that “A gate voltage can be applied to near a gate voltage at which an absolute value of a TCR is maximized by applying the gate voltage between the first upper limit value and the first lower limit value”. For this reason, in the bolometer 1 of the disclosure, it is easy to achieve a high TCR.

Further, in the bolometer 1 of the disclosure, “the carbon nanotube is a semiconductor type carbon nanotube”, and thus it is also possible to obtain an effect that “the absolute value of the TCR of the bolometer 1 can be improved”.

Further, in the bolometer 1 of the disclosure, “the first film 16 covers the drain electrode 14 and the source electrode 15”, and thus it is also possible to obtain an effect that “A contact area between the CNT 161 in the CNT network and the drain electrode 14 or the source electrode 15 increases, and the resistance of the bolometer 1 can be lowered”.

The order of the procedures disclosed above can be changed as appropriate. For example, the order of the processing procedures (step S11 to step S14) of the detection method may be changed. For example, a first upper limit value, a median, and a first lower limit value of a gate voltage (ST12 to ST14) may be determined from expected characteristic data and a TCR curve, which are obtained in advance, a negative drain voltage may be applied (ST11), and then ST15 and ST16 may be performed.

For example, the insulating layer 13 disclosed above may be substantially doped on the first film 16.

For example, when there is a fixed charge in the insulating layer 13 disclosed above, a situation in which a gate voltage is effectively applied to the bolometer 1 may be reproduced, and N-type doping may actually occur. In this case, the operator may perform P-type doping with the second film 17 to move a minimum value of the TCR curve to near a gate voltage 0 V. For example, as an example of the insulating layer 13 with a fixed charge, silicon nitride can be cited.

In the above disclosure, it is disclosed that a gate voltage between the first upper limit value and the first lower limit value is applied to the gate electrode 12 from a state where a negative drain voltage is applied to the drain electrode 14 of the bolometer 1, and thus a gate voltage can be applied to near a gate voltage at which an absolute value of a TCR is at a maximum.

On the other hand, in a bolometer 100 to be disclosed below, a gate electrode 12 and a source electrode 15 are short-circuited, and the bolometer 100 can be driven at a gate voltage of 0 V. Focus is given on the fact that it is easy to maximize an absolute value of a TCR when the bolometer 100 is driven at a gate voltage of 0 V by moving a minimum value of a TCR curve to the vicinity of the gate voltage of 0 V by a doping action or a de-doping action of a second film 17B. The term “de-doping action” as used herein generally refers to an action of canceling P-type doping due to oxygen and water adsorbed on CNTs.

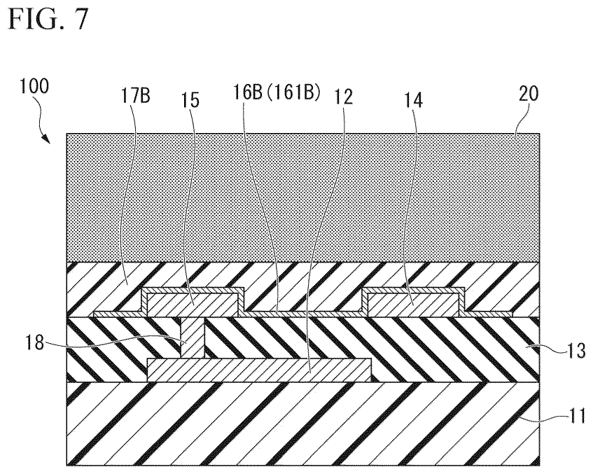

An example of a configuration of the bolometer in the disclosure will be described below with reference to FIGS. 7 to 9.

Furthermore, the same reference numerals are given to the same components as those disclosed above, and detailed description thereof will be omitted.

### (Configuration of Bolometer)

As shown in FIG. 7, the bolometer 100 includes a substrate 11, the gate electrode 12, an insulating layer 13, a drain electrode 14, the source electrode 15, a first film 16B, the second film 17B, and an infrared ray absorption layer 20, and further includes a short circuit member 18.

### (Second Film 17B)

The second film 17B includes a low-molecular material, a polymer material, or the like as a material that performs a doping action or a de-doping action.

For example, the second film 17B may contain P4VP or P4VBM. For example, the second film 17B may contain a polymer material (for example, P4VP or P4VBM) in which 4-(2,3-dihydro1,3-dimethyl-1H-benzimidazol-2-yl)-N,N-dimethylbenzenamine (N-DMBI), which is a known low-molecular material, is dispersed by performing N-type doping. In addition, as a low-molecular material, various materials other than N-DMBI may be selected as long as stable doping is achieved.

For example, P4VP or P4VP having N-DMBI dispersed therein performs de-doping from a P-type or performs N-type doping on a CNT 161B contained in the first film 16B.

For example, P4VBM or P4VBM having N-DMBI dispersed therein performs de-doping from a P-type or performs N-type doping on the CNT 161B contained in the first film 16B.

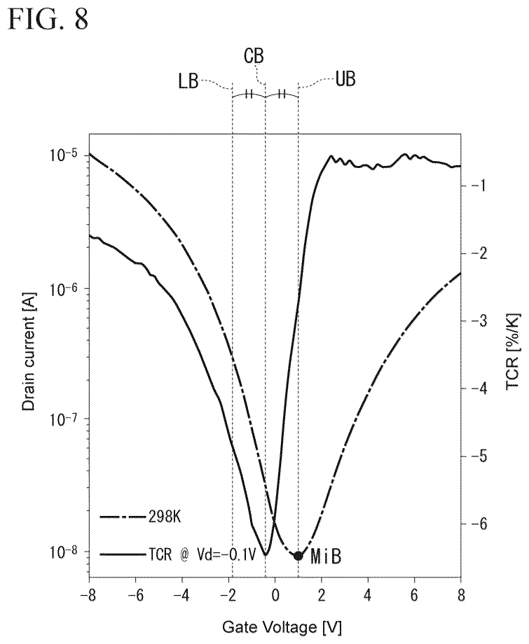

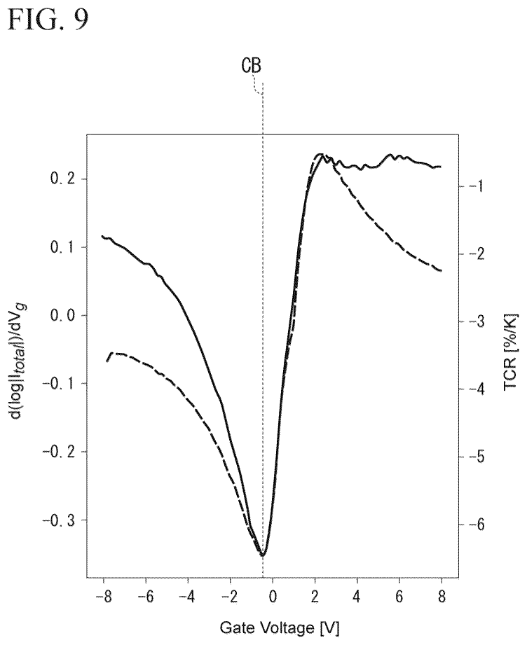

In FIGS. 8 and 9, a first upper limit value, a median, and a first lower limit value of a gate voltage of the first film 16B containing the CNT 161B having been subjected to de-doping from a P-type or N-type doping are as follows. Graphs in FIGS. 8 and 9 are obtained when a gate voltage is swept over from the state of a predetermined drain voltage (V_{d}=−0.1 V) for the bolometer 100.

The first upper limit value of the gate voltage is a gate voltage indicated by a line UB shown in FIG. 8 at a point MiB where a drain current I_{d} of the drain electrode 14 is at a minimum.

The median of the gate voltage is a gate voltage value indicated by a line CB shown in FIG. 8. As shown in FIG. 9, a gate voltage at which an absolute value of a TCR is at a maximum and a gate voltage of argmax|d log|Iₜₒₜₐₗ(V_{g})|/dV_{g}| match at the gate voltage indicated by the line CB. The gate voltage value indicated by the line CB is near 0 V.

The first lower limit value of the gate voltage is a gate voltage that satisfies relationships shown in Equations (1) and (2) in, such as a line LB shown in FIG. 8. The line LB is line-symmetrical to the line UB in the line CB.

### (Short Circuit Member)

The short circuit member 18 short-circuits the gate electrode 12 and the source electrode 15.

The potential of the gate electrode 12 becomes equal to the potential of the source electrode 15 by the short circuit member 18. For example, in the case of the source electrode 15 disclosed above, a gate voltage is 0 V.

### (Manufacturing Method)

An example of a method of manufacturing the bolometer 100 disclosed herein will be described.

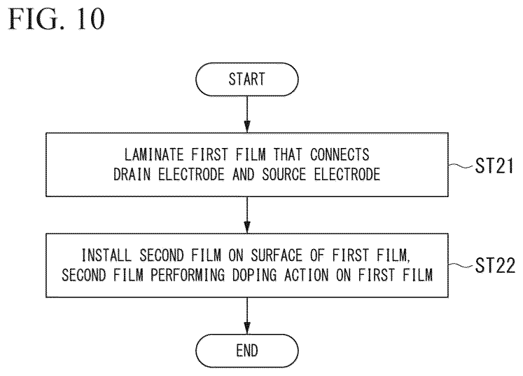

In this example, the method of manufacturing the bolometer 100 of the disclosure is performed in accordance with a flow shown in FIG. 10.

First, the operator connects the drain electrode 14 and the source electrode 15 and laminates the first film 16B containing a carbon nanotube (ST21).

Next, the operator provides the second film 17B on the surface of the first film 16B, the second film 17B performing a de-doping action from a P-type or an N-type doping action on the first film 16B (ST22).

In ST22, when a drain voltage to be applied to the drain electrode 14 is negative, the operator provides the second film 17B so that a gate voltage (0 V) to be applied to the gate electrode 12 is set between the first upper limit value and the first lower limit value.

The first upper limit value is the gate voltage when a drain current of the drain electrode 14 is at a minimum, and the first lower limit value is the gate voltage that satisfies the relationships shown in Equations (1) and (2).

Here, the bolometer 100 to which a predetermined voltage is applied by the gate electrode 12 having the same potential as that of the source electrode 15 is manufactured. (completed)

### (Action and Effect)

According to the bolometer 100 of the disclosure, a gate voltage between a first upper limit value and a first lower limit value is applied, and thus the bolometer 100 can be driven near a gate voltage at which an absolute value of a TCR is at a maximum.

Furthermore, the bolometer 100 of the disclosure can be driven at a gate voltage of 0 V by the gate electrode 12 having the same potential as the potential of the source electrode 15 connected to a GND. By performing a de-doping action from a P-type or N-type doping on the second film 17B, a minimum value of a TCR curve is moved to near a gate voltage of 0 V. Thereby, when the bolometer 100 is driven at a gate voltage of 0 V, an absolute value of a TCR can be easily maximized.

Thus, in the bolometer 100 of the disclosure, it is easy to achieve a high TCR.

For example, as a modification example of the method of manufacturing the bolometer 100 of the disclosure, the operator may perform a step of short-circuiting the gate electrode and the source electrode before ST21.

For example, the operator may short-circuit the gate electrode 12 and the source electrode 15 by using the short circuit member 18.

### (Change in TCR Curve)

It is said that the TCR curve exists in a positive direction (negative direction) of a gate voltage depending on each condition compared to a TCR curve obtained under vacuum. For example, the TCR curve changes depending on whether a drain voltage to be applied to the bolometer 100 is positive (negative) and whether doping performed on the first film 16B is a P-type (a de-doping action from a P-type or N-type doping).

As disclosed above, the TCR curve has a minimum value when a gate voltage value near a specific voltage (hereinafter referred to as a “specific gate voltage value”) is applied. For example, it is assumed that a specific gate voltage value having a minimum value in a TCR curve obtained under vacuum is 0 V. When the bolometer 100 is operated under vacuum, an absolute value of a TCR can be maximized at a specific gate voltage value of 0 V. In addition, the specific gate voltage value may change slightly from 0 V depending on a work function of the gate electrode or the like.

Here, the “doping action” of the second film 17B (or the second film 17 described above) will be described in detail with reference to FIG. 11.

For example, the second film 17B contains P4VP. The P4VP performs de-doping from a P-type or N-type doping on the CNT 161 contained in the first film 16.

FIG. 11 shows transport characteristics of the bolometer 100 having a CNT network in the first film 16B, the CNT network being a network in which N-type doping is performed on the CNT 161B.

For example, FIG. 11 shows comparison between the TCR curve having been subjected to P-type doping in FIG. 2 and a TCR curve having been subjected to de-doping from a P-type or N-type doping in the same drawing. The transport characteristics and the TCR curve when the de-doping from a P-type or the N-type doping are performed in FIG. 11 are acquired under the same conditions as in FIG. 2. Here, curves indicating the transport characteristics and the TCR curve when P-type doping has been performed are shown as thin lines. In addition, curves indicating the transport characteristics and the TCR curve when the de-doping from a P-type or the N-type doping has been performed are shown as thick lines.

It can be understood that the TCR curve (thick solid line) having been subjected to the de-doping from a P-type or the N-type doping exists in the negative direction of a gate voltage, in contrast to the TCR curve (thin solid line) having been subjected to the P-type doping.

Furthermore, CNTs are inherently electrically neutral. However, the CNT 161B may be subjected to P-type doping with water or oxygen, for example, under an atmospheric environment. Thus, the first film 16B containing the CNT 161B may be subjected to P-type doping with water or oxygen. When the second film 17B is not installed, the transport characteristics and the TCR curve of the first film 16B containing the CNT 161B having been subjected to P-type doping with water or oxygen tend to be similar to those in the graph of FIG. 2.

From the above, a TCR curve can be moved, for example, by performing de-doping from a P-type or N-type doping on the CNT 161B having already been subjected to P-type doping by the second film 17B. In this case, a minimum value of the TCR curve may be moved to near a gate voltage of 0 V by performing the de-doping from a P-type or the N-type doping by the second film 17B. Thereby, when the bolometer is driven at a gate voltage of 0 V, a value close to the minimum value in the moved TCR curve is taken. Thus, when the bolometer is driven at a gate voltage of 0 V, an absolute value of a TCR can be a maximum value, thereby improving detection performance of the bolometer 100. In this manner, the operator can create a situation similar to a case where the bolometer 100 is operated under vacuum.

In the bolometer 100 of the disclosure, it is possible to obtain the following effects by “the bolometer 100 including the gate electrode 12 to which a gate voltage can be applied, the drain electrode 14 to which a drain voltage can be applied, the source electrode 15, the first film 16B that connects the drain electrode 14 and the source electrode 15 and contains the carbon nanotube 161B, and the second film 17B that performs a doping action on the first film 16B, in which when the drain voltage is negative, the gate voltage is set between a first upper limit value and a first lower limit value, and the first upper limit value is the gate voltage when a drain current of the drain electrode 14 is at a minimum, and the first lower limit value is the gate voltage that satisfies relationships shown in Equations (1) and (2)”.

In the bolometer 100 of the disclosure, it is possible to obtain an effect that “A TCR curve can be moved, and therefore the bolometer 100 can be driven near a gate voltage at which an absolute value of a TCR is maximized by setting the gate voltage at which the absolute value of the TCR is maximized near a predetermined voltage value”.

Further, in the bolometer 100 of the disclosure, the following effects can be obtained by “the gate electrode 12 and the source electrode 15 being short-circuited”.

In the bolometer 100 of the disclosure, it is also possible to obtain an effect that “the bolometer 100 can be driven at a gate voltage of 0 V by the gate electrode 12 having the same potential as the potential of the source electrode 15 connected to a GND, and a minimum value of a TCR curve is moved to near a gate voltage of 0 V by a de-doping action from a P-type or N-type doping of the second film 17B, and thus an absolute value of a TCR can be easily maximized when the bolometer 100 is driven at a gate voltage of 0 V”.

For example, the second film 17B disclosed above may be appropriately selected as necessary so that the absolute value of the TCR can be maximized at a set gate voltage. Two examples are shown below.

For example, when the bolometer 100 is under vacuum, the absolute value of the TCR may be maximized near 0 V. In this case, when it is not necessary to move the TCR curve, the operator does not need to select the second film 17B that performs P-type doping.

For example, the CNT 161B may be subjected to P-type doping with water or oxygen under an atmospheric environment, and additionally, may be substantially subjected to N-type doping with a fixed charge of the insulating layer 13. In this case, when the absolute value of the TCR can be maximized near 0 V, the operator determines that it is not necessary to move the TCR curve and does not need to select the second film 17B that performs P-type doping.

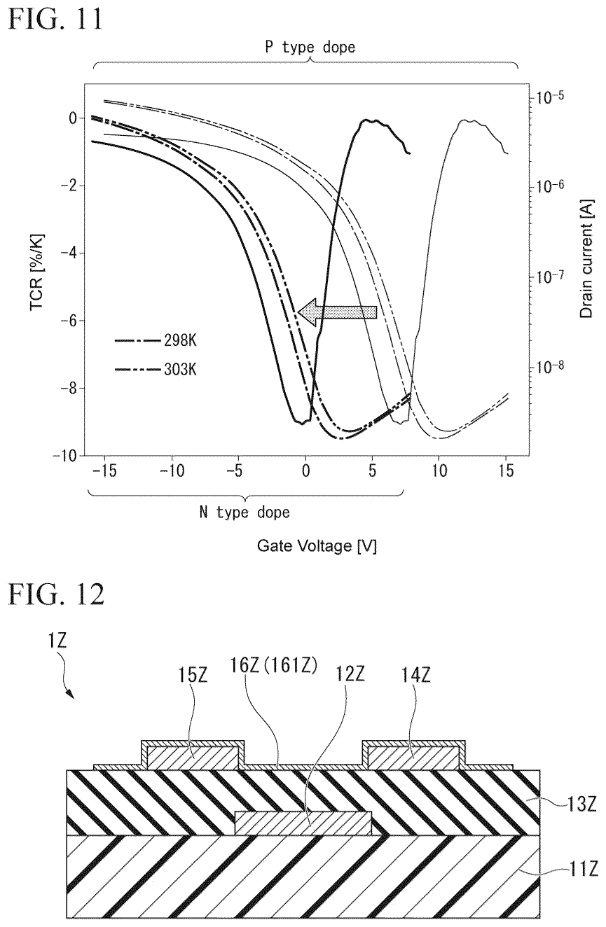

An example of a configuration of the bolometer in the disclosure will be described below with reference to FIG. 12.

### (Configuration)

A bolometer 1Z includes a gate electrode 12Z to which a gate voltage is configured to be applied, a drain electrode 14Z to which a drain voltage is configured to be applied, a source electrode 15Z, and a first film 16Z that connects the drain electrode 14Z and the source electrode and contains a carbon nanotube 161Z. When the drain voltage is negative, the gate voltage is set between a first upper limit value and a first lower limit value, and the first upper limit value is the gate voltage when a drain current of the drain electrode 14 is at a minimum, and the first lower limit value is the gate voltage that satisfies relationships shown in Equations (1) and (2).

### (Action and Effect)

According to the bolometer 1Z of the disclosure, a gate voltage between a first upper limit value and a first lower limit value is applied, and thus it is possible to apply a gate voltage to near a gate voltage at which an absolute value of a TCR is maximized.

Thus, in the bolometer 1Z of the disclosure, it is easy to achieve a high TCR.

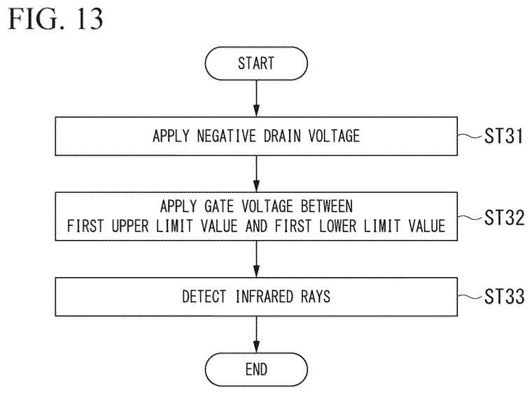

An example of a detection method in the disclosure will be described below with reference to FIG. 13.

An example of the detection method in the disclosure is performed in accordance with a flow shown in FIG. 13.

In the detection method, for a bolometer that includes a gate electrode, a drain electrode, a source electrode, a first film that connects the drain electrode and the source electrode and contains a carbon nanotube, a negative drain voltage is applied to the drain electrode (ST31), a gate electrode between a first upper limit value and a first lower limit value is applied to the gate electrode (ST32), infrared rays are detected (ST33), the first upper limit value is the gate voltage at which a drain current of the drain electrode is at a minimum, and the first lower limit value is the gate voltage that satisfies relationships shown in Equations (1) and (2).

### (Action and Effect)

According to the detection method of the disclosure, a gate voltage between a first upper limit value and a first lower limit value is applied, and thus it is possible to apply a gate voltage to near a gate voltage at which an absolute value of a TCR is maximized.

Thus, in the detection method of the disclosure, it is easy to achieve a high TCR.

Although the disclosure has been described above with reference to the example embodiment, the disclosure is not limited to the above-described example embodiment. Various changes that can be understood by those skilled in the art can be made to the configurations and details of the disclosure within the scope of the disclosure. Each example embodiment can be combined with other example embodiments as appropriate.

Some or all of the above-described example embodiments may be described as the following supplementary notes, but are not limited to the following.

### (Supplementary Note 1)

A bolometer including:
a gate electrode to which a gate voltage is configured to be applied;
a drain electrode to which a drain voltage is configured to be applied;
a source electrode; and
a first film that connects the drain electrode and the source electrode and includes a carbon nanotube, wherein
when the drain voltage is negative, the gate voltage is set between a first upper limit value and a first lower limit value,
the first upper limit value is the gate voltage when a drain current of the drain electrode is at a minimum, and
the first lower limit value is the gate voltage that satisfies relationships shown in the following equation:

$$first lower limit value = first upper limit value - ( first upper limit value - median ) \times 2$$

$$where ,$$

$$median = argmax \vert \frac{dlog \vert {I}_{total} ( {V}_{g} ) \vert}{{d V}_{g}} \vert .$$

### (Supplementary Note 2)

The bolometer according to supplementary note 1, further including:
a second film that is provided on a surface of the first film and performs a doping action on the first film.

### (Supplementary Note 3)

The bolometer according to supplementary note 2,
wherein the gate electrode and the source electrode are short-circuited.

### (Supplementary Note 4)

The bolometer according to any one of supplementary notes 1 to 3, wherein
when the drain voltage is negative, the gate voltage is set between a second upper limit value and a second lower limit value,
the second upper limit value satisfies a relationship shown in the following equation: second upper limit value=median+(first upper limit value−median)/2, and
the second lower limit value satisfies a relationship shown in the following equation: second lower limit value=second upper limit value−(second upper limit value−median)×2.

### (Supplementary Note 5)

The bolometer according to supplementary note 2 or 3,
wherein the second film includes a polymeric material.

### (Supplementary Note 6)

The bolometer according to supplementary note 2 or 3,
wherein the second film includes PMMA, P4VP, or P4VBM.

### (Supplementary Note 7)

The bolometer according to supplementary note 1 or 2,
wherein the carbon nanotube is a semiconductor type carbon nanotube.

### (Supplementary Note 8)

The bolometer according to supplementary note 1 or 2,
wherein the first film covers the drain electrode and the source electrode.

### (Supplementary Note 9)

A detection method for a bolometer including a gate electrode, a drain electrode, a source electrode, and a first film that connects the drain electrode and the source electrode and includes a carbon nanotube, the detection method including:
applying a negative drain voltage to the drain electrode;
applying a gate voltage between a first upper limit value and a first lower limit value to the gate electrode; and
detecting infrared rays, wherein
the first upper limit value is the gate voltage when a drain current of the drain electrode is at a minimum, and
the first lower limit value is the gate voltage that satisfies relationships shown in the following equation:

$$first lower limit value = first upper limit value - ( first upper limit value - median ) \times 2$$

$$where ,$$

$$median = argmax \vert \frac{dlog \vert {I}_{total} ( {V}_{g} ) \vert}{{d V}_{g}} \vert .$$

### (Supplementary Note 10)

The detection method according to supplementary note 9, wherein
in the applying of the gate voltage, when the drain voltage is negative, the gate voltage is set between a second upper limit value and a second lower limit value,
the second upper limit value satisfies a relationship shown in the following equation: second upper limit value=median+(first upper limit value−median)/2, and
the second lower limit value satisfies a relationship shown in the following equation: second lower limit value=second upper limit value−(second upper limit value−median)×2.

### (Supplementary Note 11)

A bolometer manufacturing method including:
laminating a first film that connects a drain electrode and a source electrode and includes a carbon nanotube; and
providing a second film on a surface of the first film, the second film performing a doping action on the first film, wherein
in the providing of the second film, the second film is provided such that a gate voltage applied to a gate electrode is set between a first upper limit value and a first lower limit value when a drain voltage applied to the drain electrode is negative,
the first upper limit value is the gate voltage when a drain current of the drain electrode is at a minimum, and
the first lower limit value is the gate voltage that satisfies relationships shown in the following equation:

$$first lower limit value = first upper limit value - ( first upper limit value - median ) \times 2$$

$$where ,$$

$$median = argmax \vert \frac{dlog \vert {I}_{total} ( {V}_{g} ) \vert}{{d V}_{g}} \vert .$$

### (Supplementary Note 12)

The bolometer manufacturing method according to supplementary note 11, wherein
in the applying of the gate voltage, when the drain voltage is negative, the gate voltage is set between a second upper limit value and a second lower limit value,
the second upper limit value satisfies a relationship shown in the following equation: second upper limit value=median+(upper limit value−median)/2, and
the second lower limit value satisfies a relationship shown in the following equation: second lower limit value=second upper limit value−(second upper limit value−median)×2.

### (Supplementary Note 13)

The bolometer manufacturing method according to supplementary note 11 or 12,
wherein, in the providing of the second film, the second film includes a polymeric material.

### (Supplementary Note 14)

The bolometer manufacturing method according to any one of supplementary notes 11 to 13,
wherein, in the providing of the second film, the second film includes PMMA, P4VP, or P4VBM.

### (Supplementary Note 15)

The bolometer manufacturing method according to any one of supplementary notes 11 to 14,
wherein, in the laminating of the first film, the carbon nanotube is a semiconductor type carbon nanotube.

### (Supplementary Note 16)

The bolometer manufacturing method according to any one of supplementary notes 11 to 15,
wherein, in the laminating of the first film, the first film covers the drain electrode and the source electrode.

According to the bolometer, the detection method, and the bolometer manufacturing method of the disclosure, it is easy to achieve a high TCR.

What is claimed is:

1. A bolometer comprising:
a gate electrode to which a gate voltage is configured to be applied;
a drain electrode to which a drain voltage is configured to be applied;
a source electrode; and
a first film that connects the drain electrode and the source electrode and includes a carbon nanotube, wherein
when the drain voltage is negative, the gate voltage is set between a first upper limit value and a first lower limit value,
the first upper limit value is the gate voltage when a drain current of the drain electrode is at a minimum, and
the first lower limit value is the gate voltage that satisfies relationships shown in the following equation:
$$first lower limit value = first upper limit value - ( first upper limit value - median ) \times 2$$
$$where ,$$
$$median = argmax \vert \frac{dlog \vert {I}_{total} ( {V}_{g} ) \vert}{{d V}_{g}} \vert .$$

2. The bolometer according to claim 1, further comprising:
a second film that is provided on a surface of the first film and performs a doping action on the first film.

3. The bolometer according to claim 2,
wherein the gate electrode and the source electrode are short-circuited.

4. The bolometer according to claim 1, wherein
when the drain voltage is negative, the gate voltage is set between a second upper limit value and a second lower limit value,
the second upper limit value satisfies a relationship shown in the following equation: second upper limit value=median+(first upper limit value−median)/2, and
the second lower limit value satisfies a relationship shown in the following equation: second lower limit value=second upper limit value−(second upper limit value−median)×2.

5. The bolometer according to claim 2,
wherein the second film includes a polymeric material.

6. The bolometer according to claim 2,
wherein the second film includes PMMA, P4VP, or P4VBM.

7. The bolometer according to claim 1,
wherein the carbon nanotube is a semiconductor type carbon nanotube.

8. The bolometer according to claim 1,
wherein the first film covers the drain electrode and the source electrode.

9. A detection method for a bolometer including a gate electrode, a drain electrode, a source electrode, and a first film that connects the drain electrode and the source electrode and includes a carbon nanotube, the detection method comprising:
applying a negative drain voltage to the drain electrode;
applying a gate voltage between a first upper limit value and a first lower limit value to the gate electrode; and
detecting infrared rays, wherein
the first upper limit value is the gate voltage when a drain current of the drain electrode is at a minimum, and
the first lower limit value is the gate voltage that satisfies relationships shown in the following equation:
$$first lower limit value = first upper limit value - ( first upper limit value - median ) \times 2$$
$$where ,$$
$$median = argmax \vert \frac{dlog \vert {I}_{total} ( {V}_{g} ) \vert}{{d V}_{g}} \vert .$$

10. The detection method according to claim 9, wherein
in the applying of the gate voltage, when the drain voltage is negative, the gate voltage is set between a second upper limit value and a second lower limit value,
the second upper limit value satisfies a relationship shown in the following equation: second upper limit value=median+(first upper limit value−median)/2, and
the second lower limit value satisfies a relationship shown in the following equation: second lower limit value=second upper limit value−(second upper limit value−median)×2.

11. A bolometer manufacturing method comprising:
laminating a first film that connects a drain electrode and a source electrode and includes a carbon nanotube; and
providing a second film on a surface of the first film, the second film performing a doping action on the first film, wherein
in the providing of the second film, the second film is provided such that a gate voltage applied to a gate electrode is set between a first upper limit value and a first lower limit value when a drain voltage applied to the drain electrode is negative,
the first upper limit value is the gate voltage when a drain current of the drain electrode is at a minimum, and
the first lower limit value is the gate voltage that satisfies relationships shown in the following equation:
$$first lower limit value = first upper limit value - ( first upper limit value - median ) \times 2$$
$$where ,$$
$$median = argmax \vert \frac{dlog \vert {I}_{total} ( {V}_{g} ) \vert}{{d V}_{g}} \vert .$$

12. The bolometer manufacturing method according to claim 11, wherein
in the applying of the gate voltage, when the drain voltage is negative, the gate voltage is set between a second upper limit value and a second lower limit value,
the second upper limit value satisfies a relationship shown in the following equation: second upper limit value=median+(upper limit value−median)/2, and
the second lower limit value satisfies a relationship shown in the following equation: second lower limit value=second upper limit value−(second upper limit value−median)×2.

13. The bolometer manufacturing method according to claim 11,
wherein, in the providing of the second film, the second film includes a polymeric material.

14. The bolometer manufacturing method according to claim 11,
wherein, in the providing of the second film, the second film includes PMMA, P4VP, or P4VBM.

15. The bolometer manufacturing method according to claim 11,
wherein, in the laminating of the first film, the carbon nanotube is a semiconductor type carbon nanotube.

16. The bolometer manufacturing method according to claim 11,
wherein, in the laminating of the first film, the first film covers the drain electrode and the source electrode.
